(19) United States
(12) Patent Application Publication
(10) Pub. No.: US 2025/0181367 A1
(43) Pub. Date: Jun. 5, 2025

(54) CONTROLLING OF A USER INTERFACE OF A SYSTEM

(71) Applicant: KONE Corporation, Helsinki (FI)

(72) Inventors: Mika BELOV, Helsinki (FI); Emilia ANTTILA, Helsinki (FI); Juhani VIRTA, Helsinki (FI); Anna KLEMETTILÄ-SORRI, Helsinki (FI); Mikko AARRAS, Helsinki (FI); Rami ANNALA, Helsinki (FI); Timo SAARNIO, Helsinki (FI)

(73) Assignee: KONE Corporation, Helsinki (FI)

(21) Appl. No.: 19/051,323

(22) Filed: Feb. 12, 2025

Related U.S. Application Data
(63) Continuation of application No. PCT/FI2022/050606, filed on Sep. 9, 2022.

(51) Int. Cl. G06F 9/451; B66B 1/34

(52) U.S. Cl. CPC G06F 9/451; B66B 1/34

(57) ABSTRACT

A method for controlling at least one user interface of a system includes: determining, on a basis of data descriptive of an individual, an indicator value descriptive of a user experience with respect to the system; comparing the indicator value to reference values; generating a control signal to cause a setting of a mode of the at least one user interface of the system to correspond the mode of the at least one user interface represented by a reference value among the plurality of reference values with which the indicator value is detected to correspond to in a comparison. Also a control system and a non-transitory computer readable medium are provided.

### TECHNICAL FIELD

The invention concerns in general the technical field of elevator systems. More particularly, the invention concerns a management of a user interface of an elevator system.

### BACKGROUND

The existing technologies enable an identification and a follow-up of individuals in a space, such as in a building, by utilizing various types of events recordable from the individuals roaming in the space. Such technologies may be based on interaction of individuals, e.g. with their personal devices, with systems in the space as well as on a positioning of individuals with applicable positioning technology and/or monitoring technology.

On the other hand, systems, such as elevator systems, in the buildings are continuously developed to provide sophisticated service to the individuals, but unfortunately some individuals have challenges to adopt new features and new ways of using the systems. This is especially the case when an individual is visiting a building some of the first times or only randomly and utilizing the elevator system may feel challenging. Challenges may e.g. arise from a field of generating service calls to the respective system, finding an optimal way of utilizing the elevator systems to reach a destination in the building, and so on.

Therefore, there is a need to introduce approaches mitigating the challenges the evolving technology is causing to individuals in a field of elevator systems.

### SUMMARY

The following presents a simplified summary in order to provide basic understanding of some aspects of various invention embodiments. The summary is not an extensive overview of the invention. It is neither intended to identify key or critical elements of the invention nor to delineate the scope of the invention. The following summary merely presents some concepts of the invention in a simplified form as a prelude to a more detailed description of exemplifying embodiments of the invention.

An object of the invention is to present a method, a control system, and a computer program for controlling at least one user interface of a system.

The objects of the invention are reached by a method, a control system, and a computer program for controlling at least one user interface of a system as defined by the respective independent claims.

According to a first aspect, a method for controlling at least one user interface of a system is provided, the method, performed by a control system, comprises:
determining, on a basis of data descriptive of an individual, an indicator value descriptive of a user experience with respect to the system,
comparing the indicator value to a plurality of reference values,
generating a control signal to cause a setting of a mode of the at least one user interface of the system to correspond the mode of the at least one user interface represented by a reference value among the plurality of reference values with which the indicator value is detected to correspond to in a comparison.

The data descriptive of the individual may be received from at least one of the following: a terminal device of the individual; a user interface of the system.

For example, the individual may be identified based on the data descriptive of the individual.

For example, the indicator value may be determined by inquiring it from data storage. The inquiring may be performed with an identity information of the individual as an attribute in the inquiring.

The generating of the control signal may be arranged to cause the at least one user interface to apply predefined settings corresponding to a mode of the user interface defined in the control signal.

Moreover, the method may further comprise:
selecting a data library corresponding to the mode of the at least one user interface defined in the control signal as a source of data to be output in the at least one user interface.

The method may also further comprise:
selecting the at least one user interface of the system for controlling in accordance with a location of the individual.

The plurality of reference values may comprise reference values representative of at least the following modes of the at least one user interface: i) a beginner mode, ii) a normal mode.

Still further, the system may be one of the following: an elevator system, an escalator, a moving walkway, an automatic door or an access gate, a smart building system.

According to a second aspect, a control system for controlling at least one user interface of a system is provided, the control system is configured to:
determine, on a basis of data descriptive of an individual, an indicator value descriptive of a user experience with respect to the system,
compare the indicator value to a plurality of reference values,
generate a control signal to cause a setting of a mode of the at least one user interface of the system to correspond the mode of the at least one user interface represented by a reference value among the plurality of reference values with which the indicator value is detected to correspond to in a comparison.

The control system may e.g. be configured to receive the data descriptive of the individual from at least one of the following: a terminal device of the individual; a user interface of the system.

The control system may also be configured to identify the individual based on the data descriptive of the individual.

The control system may be configured to determine the indicator value by inquiring it from data storage. For example, the control system may be configured to perform the inquiring with an identity information of the individual as an attribute in the inquiring.

Moreover, the control system may be arranged the generating of the control signal to cause the at least one user interface to apply predefined settings corresponding to a mode of the user interface defined in the control signal.

The control system may further be configured to:
select a data library corresponding to the mode of the at least one user interface defined in the control signal as a source of data to be output in the at least one user interface.

Still further, the control system may further be configured to:
select the at least one user interface of the system for controlling in accordance with a location of the individual.

The plurality of reference values may comprise reference values representative of at least the following modes of the at least one user interface: i) a beginner mode, ii) a normal mode.

The control system may be configured to control the system being one of the following: an elevator system, an escalator, a moving walkway, an automatic door or an access gate, a smart building system.

According to a third aspect, a computer program is provided, the computer program comprising instructions to cause a control system according to the second aspect to execute the steps of the method according to the first aspect.

The expression “a number of” refers herein to any positive integer starting from one, e.g. to one, two, or three.

The expression “a plurality of” refers herein to any positive integer starting from two, e.g. to two, three, or four.

Various exemplifying and non-limiting embodiments of the invention both as to constructions and to methods of operation, together with additional objects and advantages thereof, will be best understood from the following description of specific exemplifying and non-limiting embodiments when read in connection with the accompanying drawings.

The verbs “to comprise” and “to include” are used in this document as open limitations that neither exclude nor require the existence of unrecited features.

The features recited in dependent claims are mutually freely combinable unless otherwise explicitly stated. Furthermore, it is to be understood that the use of “a” or “an”, i.e. a singular form, throughout this document does not exclude a plurality.

### BRIEF DESCRIPTION OF FIGURES

The embodiments of the invention are illustrated by way of example, and not by way of limitation, in the figures of the accompanying drawings.

FIG. 1 illustrates schematically a system according to an example.

FIG. 2 illustrates schematically user interfaces according to an example.

FIG. 3 illustrates schematically a method according to an example.

FIG. 4 illustrates schematically a further aspect of a method according to an example.

FIG. 5 illustrates schematically a control system according to an example.

### DESCRIPTION OF THE EXEMPLIFYING EMBODIMENTS

The specific examples provided in the description given below should not be construed as limiting the scope and/or the applicability of the appended claims. Lists and groups of examples provided in the description given below are not exhaustive unless otherwise explicitly stated.

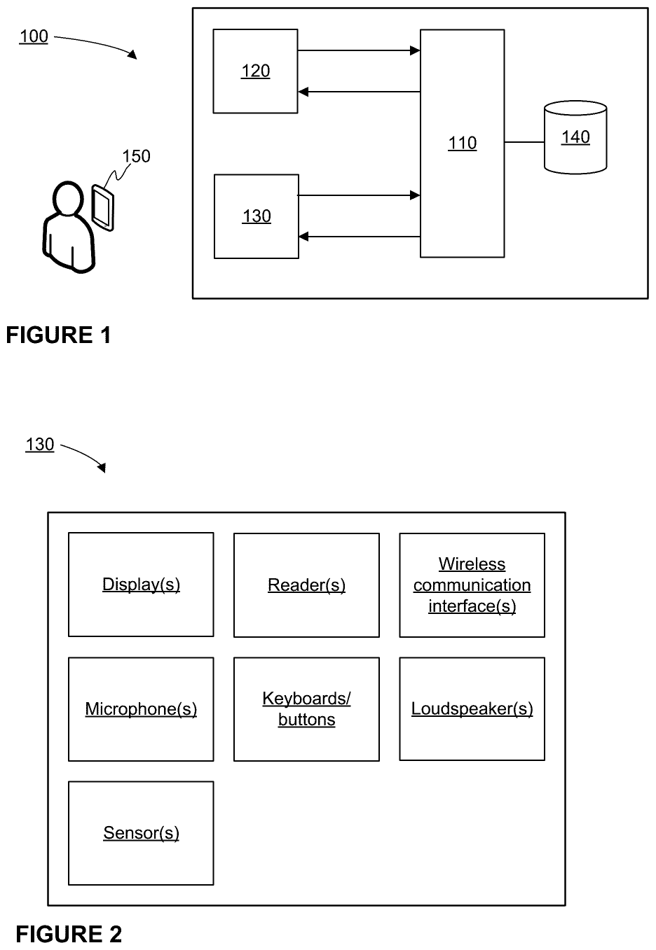

The present invention relates to utilizing one or more user interfaces of a system, such as an elevator system, an escalator, a moving walkway, an automatic door or an access gate, a smart building system, so as to provide information to individuals in accordance with their experience with respect to the system. FIG. 1 illustrates schematically an example of a system 100 in which the present invention may be implemented to. The system 100 may comprise a number of operating systems 120, which are configured to provide a service in question to the individuals. For example, in case of an elevator system the operating system 120 may consist of a number of elevators, i.e. the portion of the elevator system 100 configurable to convey passengers from one floor to another. The operation of the system 100 is controlled by a control system 110. For the purpose of the present invention a number of user interfaces 130 of the system 100 is shown as a separate entity in FIG. 1. The control system 110 of the system 100 is communicatively connected to other entities of the system 100 either directly or indirectly to transfer information between the entities and to control them. Still further, the system 100 may be provided with an access to data stored in data storage 140. The data may be stored in a database hosted by the data storage 140. The data stored therein may comprise various type of data including data related to individuals visiting the building. In accordance with the present invention the data may be indicative on a user experience at least with respect to the system 100. The data indicative of the user experience may be established based on various pieces of information. For example, the pieces of information may comprise data indicative of at least one of the following: a visiting history of an individual in the building, an operation history of the operating system 120 by an individual either in the building in question or in another building having the same type of elevator system, biometric data of an individual (e.g. age, . . . ), and so on.

FIG. 2 illustrates schematically at least some applicable user interfaces 130 of the system 100. The system 100 may comprise one or more displays, one or more readers, one or more wireless communication interfaces, one or more microphones, one or more keyboards/buttons, one or more loudspeakers, one or more sensor(s), and so on as user interfaces 130 of the system 100. Some of the user interfaces 130 may be bi-directional, i.e. user may provide input as well as receive output through it. Such user interfaces 130 may e.g. be touch screens as displays and wireless communication interface(s) over which a user may e.g. communicate with her/his terminal device as denoted with 150 in FIG. 1. The reader(s) may e.g. be devices with whom the individual may interact with a device possessed by the individual. Such a device may e.g. be a RFID tag, a magnetic card, or the terminal device 150, for example, wherein the reader may receive a predefined piece of data stored in the respective device through a physical or a wireless coupling. The sensor(s) may e.g. comprise one or more camera devices. The user interfaces 130 of the system 100 may be positioned in various locations at the space the system 100 resides and at least some of them may reside in different locations to at least some other user interfaces 130.

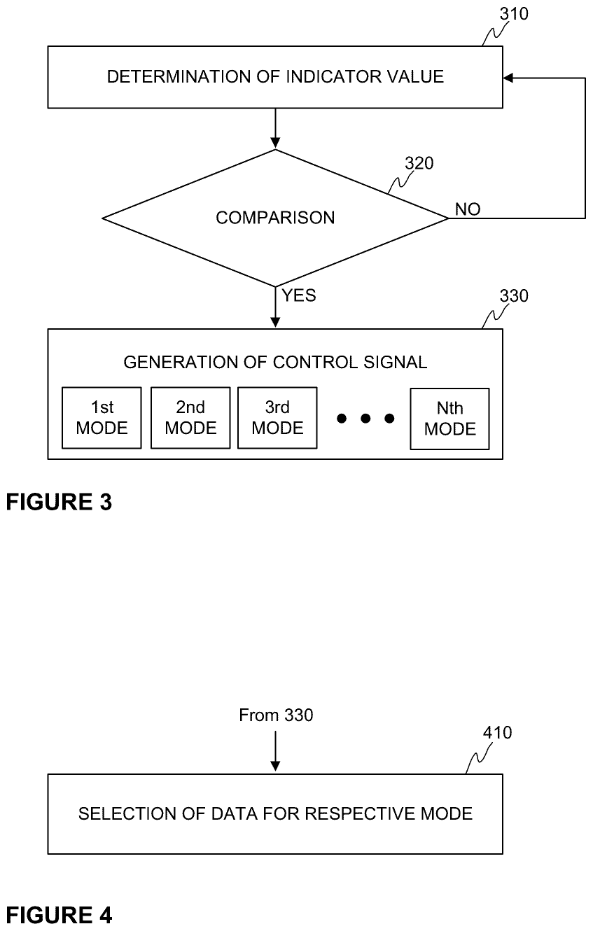

FIG. 3 illustrates schematically an example of a method according to an embodiment of the invention. The aim of the method is to control at least one user interface 130 of the system 100, such as an elevator system, in order to enable a provision of information to individuals in the premises of the system 100.

First, the control system 110 is configured to determine 310, on a basis of data descriptive of an individual, an indicator value descriptive of a user experience with respect to the system 100 residing in the premises the individual is visiting. The data descriptive of the individual for the determination 310 may be received in any manner, such as by receiving it from the individual, and it may be any kind of data by means of which the individual may be identified at least at a level that data stored in data storage 140 with respect to the individual may be inquired and/or at least determined if such data is available at all from the data storage 140. The data indicative of the identity of the individual may be received over at least one user interface 130 through with data may be input to and received by the control system 110. Hence, the data indicative of the identity of the individual may be received from a terminal device 150 of the individual over a wireless communication interface the terminal device 150 is connected to wherein the wireless communication interface may refer to a communication interface over a mobile communication network, over a wireless local area network, over near field communication (NFC), RFID, and so on. The piece of data delivered for identifying the individual may be stored in a memory of the terminal device 150 and obtained automatically or manually therefrom e.g. by the application program for delivering it to the control system 110. Naturally, it is possible to arrange that the piece of data identifying the individual may be input by the user through a user interface of the terminal device 150. Still further, the data identifying the individual may also be obtained in some other manner, such as by using an interface 130 communicatively connected to the control system 110 in a manner required by the interface. The interface may herein refer to any type of reader device with which the individual may interact with any device or similar, such as a tag or a magnetic card, in order to transfer the piece of data. Naturally, the individual may input data identifying the individual with keyboards/buttons, touch screens, or even over microphone as examples of user interfaces suitable for inputting the data indicative of the identity of the individual to the control system 110. Still further, sensors, such as a camera, may be used for receiving data on the individual wherein the image data may be processed to identify the individual at a necessary level. The processing may e.g. comprise applying a face recognition algorithm to the image data representing at least the individual in question. Further applicable identification methods may be based on palm print/fingerprint detection, gait recognition, iris recognition, or on other known biometric recognition methods.

As derivable from the foregoing description, the data received in relation to the individual allows the control system 110 to perform the step of determining 310, on a basis of data received in relation to an individual, a user experience of the individual, with respect to the system 100. The determination 310 may be based on a generation of an inquiry to data storage arranged to store data descriptive of the user experience on individual basis. The accuracy of the data representing the user experience and stored in the data storage 140 may be based on various approaches. The definition of the user experience may e.g. be based on a number of visits the individual has done in the premises, but also more sophisticated approaches may be applied to. For example, the user experience may be defined at a plurality of levels, such as ‘beginners’, ‘normal users’, and ‘expert users’ and each of these levels may have requirements in order to that an individual may be classified to one of these classes. For example, the individuals of whom there is not stored any data entry in the data storage 140 are always considered as beginners and remained there until they have visited the building and/or used the elevator system 120 X number of times. Correspondingly, the expert users may be those individuals who are e.g. permanent inhabitants in the premises. Further, the normal users are something between these other two. As said, the classification in the described manner is a non-limiting example and other approaches for classification may be applied to. In other words, the data storage 140 may return an indicator value descriptive of the user experience with respect to the system 100 in response to the inquiry wherein an identity of the individual may be used as an attribute in the inquiry.

In response to a receipt of the indicator value from the data storage 140 the control system 110 is configured to compare 320 the indicator value to a plurality of reference values. Each reference value is, in accordance with the embodiment of the present invention, defined to represent a user group having a predefined user experience with respect to the system 100 in question. Hence, different reference values represent different user experiences with respect to the system 100 in question. For example, one reference value may correspond to a user group of unexperienced users of the system 100. In other words, the aim in the comparison step is to find out the user experience of the individual with respect to the system 100. For example, if the data storage has returned data descriptive that the individual is ‘beginner’, the control system 110 may be configured to generate a correspondence in the comparison 320 step with the reference value defined for the unexperienced user of the system 100. The same kind of correspondence may be found with respect to other user groups defined based on the experience with respect to the system 100, such as being normal experience and expert experience, for instance. The term ‘correspondence’ shall be understood as a discrete match in the compared values, but it may also cover approaches in which the reference values are defined as ranges and if the indicator value belongs to a certain range, a respective mode corresponding to the reference value range is selected to.

In accordance with some other example embodiment it may be arranged that the data storage 140 directly returns an indication that the individual is user with a certain predefined experience in response to the inquiry. Hence, the comparison 320 is implemented as a cooperation of the control system 110 and the data storage 140. Even in this kind of approach the control system 110 performs a detection through a comparison 320 that the indication received from the data storage 140 corresponds to a reference value defining a level of experience.

In case the comparison 320 does not generate a detection of the unexperienced user the control system 110 may continue the monitoring and determination 310 of the indicator value in the described manner as indicated with an arrow returning to the step 310 from the step 320 in FIG. 3.

In case the control system 110 generates a detection through the comparison 320 that the individual under monitoring represented with the indicator value corresponds to one user group represented by the reference values indicative on the experience with respect to the system 100 it causes the control system 100 to generate 330a control signal to cause a setting of a mode of the at least one user interface 130 of the system 100 to correspond the mode of the at least one user interface 130 represented by a reference value among the plurality of reference values with which the indicator value is detected to correspond to, such as to match, in the comparison 320. For example, the detection through the comparison may e.g. cause an occurrence of at least one of the following: i) setting of a mode of at least one user interface 130 of the elevator system 100 to a beginner mode; setting a mode of the at least user interface 130 in a normal mode. Naturally, the user interface 130 may have a default mode activated unless other information is received which default mode may e.g. be the normal mode. Hence, in case the method as described generates an outcome that the mode shall be set to the normal mode the control system 110 is configured to confirm a maintenance of the normal mode already executed by the user interface 130. In FIG. 3 the various modes selectable through the comparison are denoted with terms: 1^{st} Mode, 2^{nd} Mode, 3^{rd} Mode, . . . , N^{th} Mode.

The setting of the user interface 130 to one of the modes by generating 330 the control signal cause the user interface 130 to apply predefined settings in order to output data to the individual in question. The settings may relate to technical parameters applied in the respective user interface 130, such as brightness, colour scheme, volume, and so on, for outputting the information to the individual in question. Moreover, the settings may also define applied a font size, a font type, a font colour, and so on in case it is the user interface which only receives the data to be output and adjusts an appearance of the information in accordance with the settings applied by the user interface 130. Hence, it may be arranged that e.g. the control system selects data to be output and transfers it to the user interface, which applies the settings in accordance with the user experience in the output of the data.

In some further example embodiments the control system 110 may be configured to select 410 data for outputting data in accordance with the user experience as is described in the forthcoming description as shown in FIG. 4. The selection 410 of the data may refer to a selection of a data library among a plurality of data libraries to be applied for outputting the information to the individual in question. The data libraries e.g. define pieces of information to be outputted to the individual through the output devices 130 wherein the pieces of information correspond to the level of the user experience in the selected data library. Hence, the control system 110 is provided with an access to a plurality of data libraries and in response to the detection of the mode the user interface 130 is instructed to set the control system 110 may select the data library for outputting the information to the individual. The different data libraries may e.g. define that the same piece of information is given with a wording, imaginary data, or audio data, dedicated to the respective user group, e.g. the unexperienced users vs. users with normal experience. Now, combining the selection of the data libraries with the setting the technical parameters of the user interface 130 in accordance with the user experience it is possible to provide personalized instructions to the individuals.

The description of at least some aspects of the present invention is described so that the user interface 130 and the individual reside so that the individual may receive the information intended for her/him by outputting the information through the user interface 130. In a more sophisticated approaches the premises, such as one or more floors in a building, may be provided with a plurality of user interfaces 130 and the user interface 130 for outputting the data selected for the individual is selected in accordance with a location of the individual in the premises. This kind of approach requires a monitoring of a location of the individual in some manner and a comparison of the location with the user interfaces 130 at the floor. The monitoring of the location of the individual may be implemented by applying an indoor positioning system configured in the premises. The indoor positioning system may e.g. be arranged to monitor a location of a device, such as a terminal device 150, a tag, or any similar, carried by the individual in question. The respective device may e.g. be communicatively connected to one or more base stations of the indoor positioning system during a visit in the premises wherein the connection generates data enabling the positioning of the individual. Alternatively or in addition, the positioning of the individual may be based on an interaction of the individual with access devices, such as doors, gates, and similar, in the premises e.g. with an access device, such as a tag or similar which allows identification of the individual based on the data transferred during the interaction. Still further, the monitoring may be implemented with sensors, such as cameras and similar, configured to generate data by means of which the individual may be identified and monitored in the premises. The location data received from the monitoring solution is compared to location data of the user interfaces 130 in the premises and a control signal to output selected information to the individual may be generated to a user interface 130 residing in a predefined vicinity of the individual.

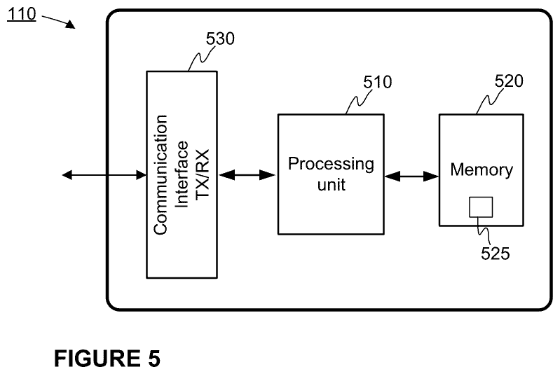

As already mentioned, the aspects of the present invention described herein are mainly done by referring to an implementation in which the controlling entity is a dedicated control system 110 as shown in FIG. 5. The functionality of the control system 110 may also be integrated to another computing device. An example of an apparatus configurable to implement the operation of the computing device, and, thus, the control system 110, is schematically illustrated in FIG. 5. In other words, the control system 110 may be configured to perform the method according to the invention as described with the examples in the foregoing description. In other words, the apparatus of FIG. 5 may be configured to perform a function to control at least one user interface 130 of an system 100. For sake of clarity, it is worthwhile to mention that the block diagram of FIG. 5 depicts some components of an entity that may be employed to implement a functionality of the apparatus.

The apparatus of FIG. 5 comprises a processor 510 and a memory 520. The memory 520 may store data, such as pieces of data as described, but also computer program code 525 causing the controlling of the user interface in the described manner. The apparatus may further comprise a communication interface 530, such as a wireless communication interface or a communication interface for wired communication, or both to communicate with other entities as described. The communication interface 530 may thus comprise one or more modems, antennas, and any other hardware and software for enabling an execution of the communication e.g. under control of the processor 510. Furthermore, I/O (input/output) components may be arranged, together with the processor 510 and a portion of the computer program code 525, to provide a user interface for receiving input from a user, such as from a technician, and/or providing output to the user of the apparatus when necessary. In particular, the user I/O components may include user input means, such as one or more keys or buttons, a keyboard, a touchscreen, or a touchpad, etc. The user I/O components may include output means, such as a loudspeaker, a display, or a touchscreen. The components of the apparatus may be communicatively connected to each other via data bus that enables transfer of data and control information between the components.

The memory 520 and at least a portion of the computer program code 525 stored therein may further be arranged, with the processor 510, to cause the apparatus to perform at least a portion of a method as is described herein. The processor 510 may be configured to read from and write to the memory 520. Although the processor 510 is depicted as a respective single component, it may be implemented as respective one or more separate processing components. Similarly, although the memory 520 is depicted as a respective single component, it may be implemented as respective one or more separate components, some, or all of which may be integrated/removable and/or may provide permanent/semi-permanent/dynamic/cached storage.

The computer program code 525 may comprise computer-executable instructions that implement functions that correspond to steps implemented in the method when loaded into the processor 510 of the respective control system 110. As an example, the computer program code 525 may include a computer program consisting of one or more sequences of one or more instructions. The processor 510 is able to load and execute the computer program by reading the one or more sequences of one or more instructions included therein from the memory 520. The one or more sequences of one or more instructions may be configured to, when executed by the processor 510, cause the apparatus to perform a method as described. Hence, the apparatus may comprise at least one processor 510 and at least one memory 520 including the computer program code 525 for one or more programs, the at least one memory 520 and the computer program code 525 configured to, with the at least one processor 510, cause the apparatus implementing the control system 110 to perform the method.

The computer program code 525 may be provided e.g. a computer program product comprising at least one computer-readable non-transitory medium having the computer program code 525 stored thereon, which computer program code 525, when executed by the processor 510, causes the apparatus to perform the method. The computer-readable non-transitory medium may comprise a memory device or a record medium, such as a CD-ROM, a DVD, a Blu-ray disc, or another article of manufacture that tangibly embodies the computer program. As another example, the computer program may be provided as a signal configured to reliably transfer the computer program.

Still further, the computer program code 525 may comprise a proprietary application, such as computer program code for causing an execution of the method in the manner as described in the description herein.

Any of the programmed functions mentioned may also be performed in firm-ware or hardware adapted to or programmed to perform the necessary tasks.

For sake of completeness it is worthwhile to mention that the entity configured to perform the method in the role of the control system 110 may also be implemented with a plurality of apparatuses, such as the one schematically illustrated in FIG. 5, as a distributed computing environment corresponding to a control system. For example, one of the apparatuses may be communicatively connected with the other apparatuses, and e.g. share the data of the method, to cause another apparatus to perform at least one other portion of the method. As a result, the method performed in the distributed computing environment generates the control signal indicative of the assignment of the responsibility as described. For example, some steps of the method may be shared between the control system 110, a controller of the elevator system 120, and a controller of the monitoring system 130, for example.

The advantage of the invention as described herein with the number of examples is that it enables a control of at least one user interface of an elevator system individually in accordance with a user experience with respect to the elevator system as described. This kind of approach may relieve stress of individuals, especially those individuals being unexperienced due to that the user interfaces are adjusted in accordance with their user experience, and even in some implementations the information is accordingly selected.

In the description above it is mainly discussed that the user interfaces 130 configured to output data for the individual are according controlled, but the same approach may also be taken with respect to user interfaces 130 utilized for receiving input from the individuals. In such approaches an appearance of the user interface 130 may be adjusted, for example.

In the description of at least some aspects of the present invention it is mainly referred to that the system 100 resides in a building. The term building shall be understood in a broad manner to cover any structures into which the elevator system 100 may be implemented covering e.g. various types of houses and ships and so on. The invention is especially advantageous with respect to systems 100 having user interfaces 130 being complex to use due to a broad range of functionalities accessible through the user interface in question. Such systems 100 may e.g. be elevator systems and access gates as non-limiting examples.

The specific examples provided in the description given above should not be construed as limiting the applicability and/or the interpretation of the appended claims. Lists and groups of examples provided in the description given above are not exhaustive unless otherwise explicitly stated.

1. A method for controlling at least one user interface of a system, the method, performed by a control system, comprises:
determining, on a basis of data descriptive of an individual, an indicator value descriptive of a user experience with respect to the system,
comparing the indicator value to a plurality of reference values,
generating a control signal to cause a setting of a mode of the at least one user interface of the system to correspond the mode of the at least one user interface represented by a reference value among the plurality of reference values with which the indicator value is detected to correspond to in a comparison.

2. The method according to claim 1, wherein the data descriptive of the individual is received from at least one of the following: a terminal device of the individual; a user interface of the system.

3. The method according to claim 1, wherein the individual is identified based on the data descriptive of the individual.

4. The method according to claim 1, wherein the indicator value is determined by inquiring it from data storage.

5. The method according to claim 4, wherein the inquiring is performed with an identity information of the individual as an attribute in the inquiring.

6. The method according to claim 1, wherein the generating of the control signal is arranged to cause the at least one user interface to apply predefined settings corresponding to a mode of the user interface defined in the control signal.

7. The method according to claim 1, the method further comprises:
selecting a data library corresponding to the mode of the at least one user interface defined in the control signal as a source of data to be output in the at least one user interface.

8. The method according to claim 1, the method further comprises:
selecting the at least one user interface of the system for controlling in accordance with a location of the individual.

9. The method according to claim 1, wherein the plurality of reference values comprises reference values representative of at least the following modes of the at least one user interface: i) a beginner mode, ii) a normal mode.

10. The method according to claim 1, wherein the system is one of the following: an elevator system, an escalator, a moving walkway, an automatic door or an access gate, a smart building system.

11. A control system for controlling at least one user interface of a system, the control system is configured to:
determine, on a basis of data descriptive of an individual, an indicator value descriptive of a user experience with respect to the system,
compare the indicator value to a plurality of reference values,
generate a control signal to cause a setting of a mode of the at least one user interface of the system to correspond the mode of the at least one user interface represented by a reference value among the plurality of reference values with which the indicator value is detected to correspond to in a comparison.

12. The control system according to claim 11, wherein the control system is configured to receive the data descriptive of the individual from at least one of the following: a terminal device of the individual; a user interface of the system.

13. The control system according to claim 11, wherein the control system is configured to identify the individual based on the data descriptive of the individual.

14. The control system according to claim 11, wherein the control system is configured to determine the indicator value by inquiring it from data storage.

15. The control system according to claim 14, wherein the control system is configured to perform the inquiring with an identity information of the individual as an attribute in the inquiring.

16. The control system according to claim 11, wherein the control system is arranged the generating of the control signal to cause the at least one user interface to apply predefined settings corresponding to a mode of the user interface defined in the control signal.

17. The control system according to claim 11, the control system is further configured to:
select a data library corresponding to the mode of the at least one user interface defined in the control signal as a source of data to be output in the at least one user interface.

18. The control system according to claim 11, the control system is further configured to:
select the at least one user interface of the system for controlling in accordance with a location of the individual.

19. The control system according to claim 11, wherein the plurality of reference values comprises reference values representative of at least the following modes of the at least one user interface: i) a beginner mode, ii) a normal mode.

20. The control system according to claim 11, wherein the control system is configured to control the system being one of the following: an elevator system, an escalator, a moving walkway, an automatic door or an access gate, a smart building system.

21. A non-transitory computer readable medium storing a computer program comprising instructions to cause a control system according to claim 11 to execute the functions recited therein.
